(19) United States
(12) Patent Application Publication
(10) Pub. No.: US 2010/0202056 A1
(43) Pub. Date: Aug. 12, 2010

(54) Electronic display assembly

(76) Inventors: Renaud Moliton, Paris (FR); Cécile Bonafos, Paris (FR)

Correspondence Address: SOFER & HAROUN LLP., 317 MADISON AVENUE, SUITE 910, NEW YORK, NY, 10017, US

(21) Appl. No.: 12/311,253

(22) PCT Filed: Sep. 20, 2007
(86) PCT No.: PCT/FR2007/051976

§ 371 Date: Jan. 27, 2010

(30) Foreign Application Priority Data
Sep. 21, 2006 (FR) 0653856

(51) Int. Cl. G02B 27/01; G02B 5/18

(52) U.S. Cl. 359/570; 359/630

(57) ABSTRACT

The invention relates to an electronic display arrangement comprising a light pipe (1) for transmitting light signals emitted by a miniature screen (2) from one of its ends, referred to as its entry surface (1A), to its other end, referred to as its exit surface (1B), and thence towards the eye (0) of a user for viewing a virtual image, the arrangement further comprising a field lens (3) interposed between said screen (2) and said entry surface (1A), the field lens having both a plane working surface (3A) of rectilinear section that is placed facing the screen (2) centered on the optical axis (L3) of said field lens, and an aspherical working surface (3B). According to the invention, said aspherical surface is placed facing said entry surface (1A), with the optical axis of the field lens and the optical axis of the light pipe coinciding, and said plane working surface (3A) is adhesively bonded to the screen (2).

The invention relates to an electronic display arrangement mounted on a frame of the pair of eyeglasses type.

Such an arrangement is described in patent document FR 04/50655.

That document describes a light pipe for use in particular with an electronic display arrangement for the purpose of transmitting light signals from one of its ends, referred to as an entry surface, to its other end, referred to as an exit surface, and thence towards the eye of a user for viewing a virtual image. The light pipe has a diffractive component on its entry surface, which component is preferably supported by an aspherical carrier surface of revolution.

The object of such an arrangement is to enable an image to be obtained of larger size while conserving good image quality and regardless of the length of the light pipe. It is thus possible to obtain a light pipe that enables an image to be displayed having an angular size that is greater than 15° and that is of good quality.

Nevertheless, it is desirable to obtain an image of size that is even larger and of quality that is better.

The invention solves this problem by proposing a display arrangement that enables an image to be obtained over a field of view greater than 21°, presenting quality up to the video graphics array (VGA) standard or indeed the wide video graphics array (WVGA) standard, while remaining compact, so as to remain lightweight, stable, comfortable, and of pleasing appearance.

Furthermore, patent documents WO 2005/124427 and GB 2 274 727 describe the association of a waveguide, and a field lens interposed between the screen and the entry surface of the waveguide, the field lens having both a plane working surface placed facing the screen centered on the optical axis of the field lens, and an aspherical working surface.

The invention provides an arrangement that is more compact, so as to obtain a display that is lightweight, stable, comfortable, and pleasing in appearance.

To do this, the invention provides an electronic display arrangement comprising a light pipe for transmitting light signals emitted by a miniature screen from one of its ends, referred to as its entry surface, to its other end referred to as its exit surface, and thence towards the eye of a user for viewing a virtual image, the arrangement being characterized in that it includes a field lens interposed between said screen and said entry surface, the field lens having both a plane working surface of rectilinear section that is placed facing the screen centered on the optical axis of said field lens, and an aspherical working surface that is placed facing said entry surface, with the optical axis of the field lens and the optical axis of the light pipe coinciding, and in that said plane working surface is adhesively bonded to the screen.

In a preferred embodiment, the screen is engaged in at least in part in said plane working surface.

Preferably, said entry surface and said aspherical working surface are separated by an air gap.

Advantageously, said field lens is positioned relative to the light pipe means of an arrangement of at least two pegs co-operating with at least two corresponding holes.

The two pegs may be carried by said field lens and the two holes by the entry surface of the light pipe.

Said pegs may be carried by a spacer frame and said holes by the entry surface of the light pipe and by the exit surface of the field lens.

Most advantageously, said aspherical working surface is diffractive.

Preferably, the thickness of said field lens is defined so that the vergence of the image of the diffractive surface of the field lens lies beyond the standard accommodation ranges of an ametropic user.

Advantageously, the vergence of the image of the diffractive surface of the field lens is either greater than 0 diopters or less than −4 diopters.

Preferably, the vergence of the image of the diffractive surface of the field lens is spaced apart from the vergence of the image of the screen by at least 4 diopters in absolute value.

Preferably, said diffractive aspherical working surface is of the “kinoform” type, satisfying the equation for an aspherical carrier surface of revolution summed with the equation for a second aspherical component of revolution modulo a step size.

Said aspherical working surface may have a light-passing surface that presents local curvature that changes sign at least once.

Preferably, said aspherical working surface includes at least one point of inflection in its radial profile at which the second derivative relative to radial distance from the center of the working surface becomes zero and changes sign on passing through zero.

Preferably, said light pipe also includes an aspherical diffractive surface on its entry surface.

Preferably, the diffractive aspherical working surface of the entry surface of said light pipe is of the “kinoform” type, satisfying the equation for an aspherical carrier surface of revolution summed with the equation for a second aspherical component of revolution modulo a step size.

Advantageously, the aspherical carrier of said aspherical working surface of the entry surface of said light pipe has a light-passing surface that presents local curvature that changes sign at least once.

Preferably, said aspherical working surface of the entry surface of said light pipe includes at least one point of inflection in its radial profile at which the second derivative relative to radial distance from the center of the working surface becomes zero and changes sign on passing through zero.

Advantageously, said entry surface of the light pipe and said aspherical working surface of the field lens are substantially parallel.

The absolute value of the difference at a given radial abscissa between the slopes of said inlet working surface of the light pipe and the harmonized slopes on the working surface of said aspherical working surface of the field lens may be less than 20% of the maximum value of one or other of said values at said abscissa.

Preferably, the absolute value of the difference between the diffractive powers of the entry faces of the light pipe and of the aspherical surface of said field lens, divided by the maximum of said diffractive powers, is less than or equal to 0.25.

And advantageously, it is ensured that:

ABS[(Ru·N_SC)−N_SE]/max[(Ru·N_SC),N_SE]

is less than or equal to 25 where:

N_SE is the number of rings on the working surface of the entry face of the light pipe;

N_SC is the number of rings on the working surface of the aspherical surface of said field lens; and

Ru is the harmonization coefficient of the working surfaces of the entry faces of the light pipe and the aspherical surface of said field lens, defined by the area of the working surface of the entry face of the light pipe divided by the area of the working surface of the aspherical surface of said field lens, for a given value of pupil diameter.

Preferably, Ru is calculated for a pupil diameter equal to 8 mm.

Advantageously, said screen has color pixels of size less than 11 μm.

The invention is described below in greater detail with the help of figures that merely show preferred embodiments of the invention.

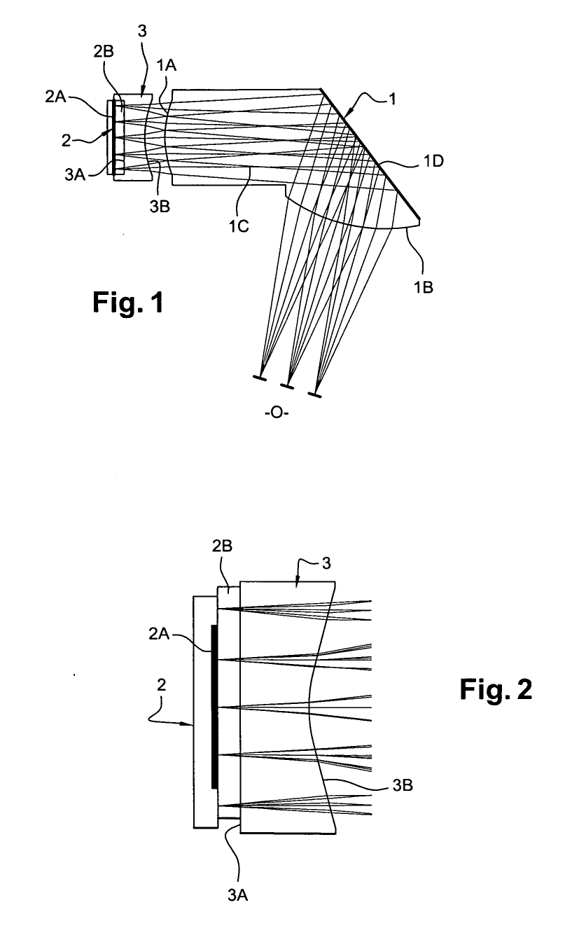

FIG. 1 is a longitudinal section view of a display arrangement in accordance with the invention.

FIG. 2 is a detail view of FIG. 1 showing a first variant embodiment of the interface between the screen and the field lens.

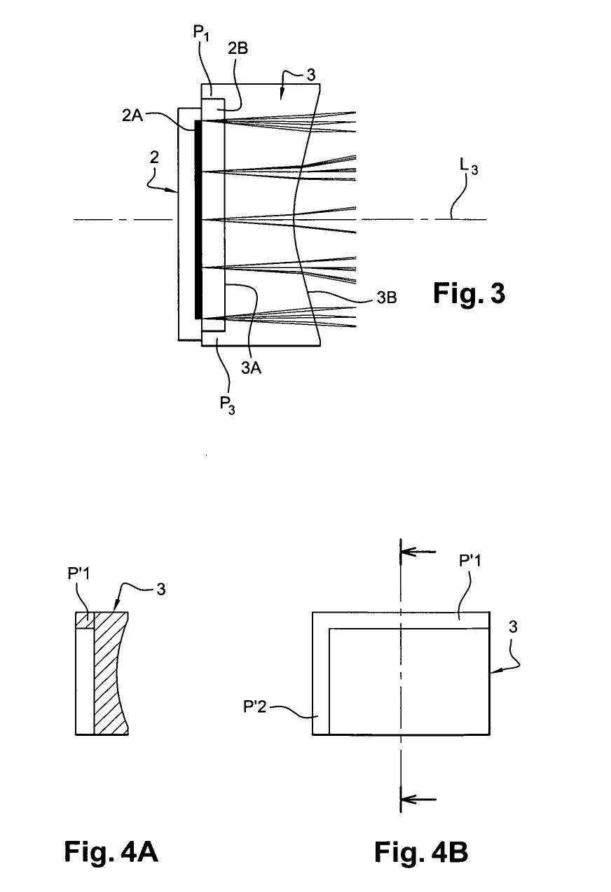

FIG. 3 is a detail view of FIG. 1 showing a second variant embodiment of the interface between the screen and the field lens.

FIGS. 4A and 4B are detail views, in longitudinal section and in face view, showing a third variant embodiment of the interface between the screen and the field lens.

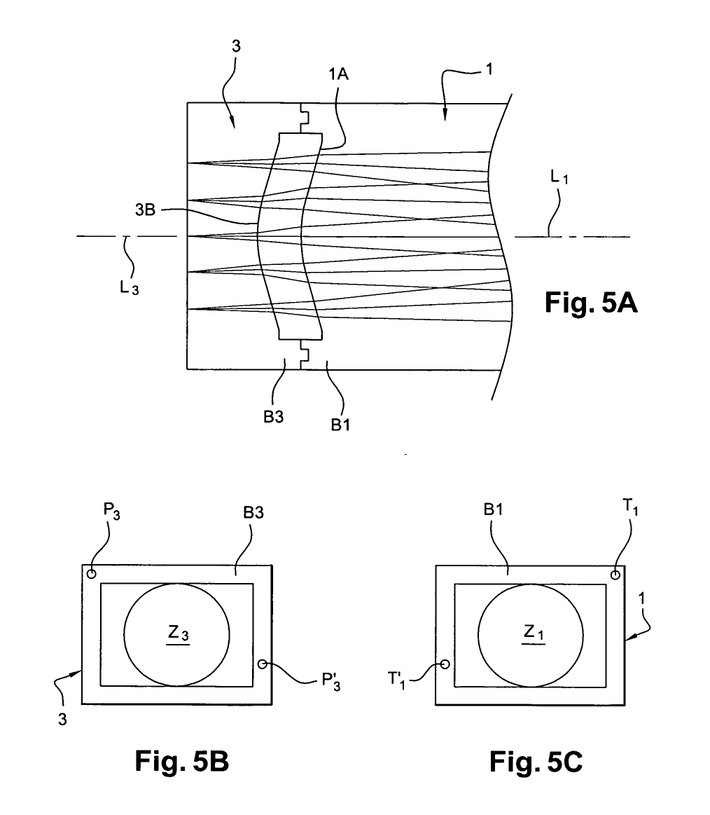

FIGS. 5A to 5C are longitudinal section and face views of a first variant embodiment of the interface between the field lens and the light pipe.

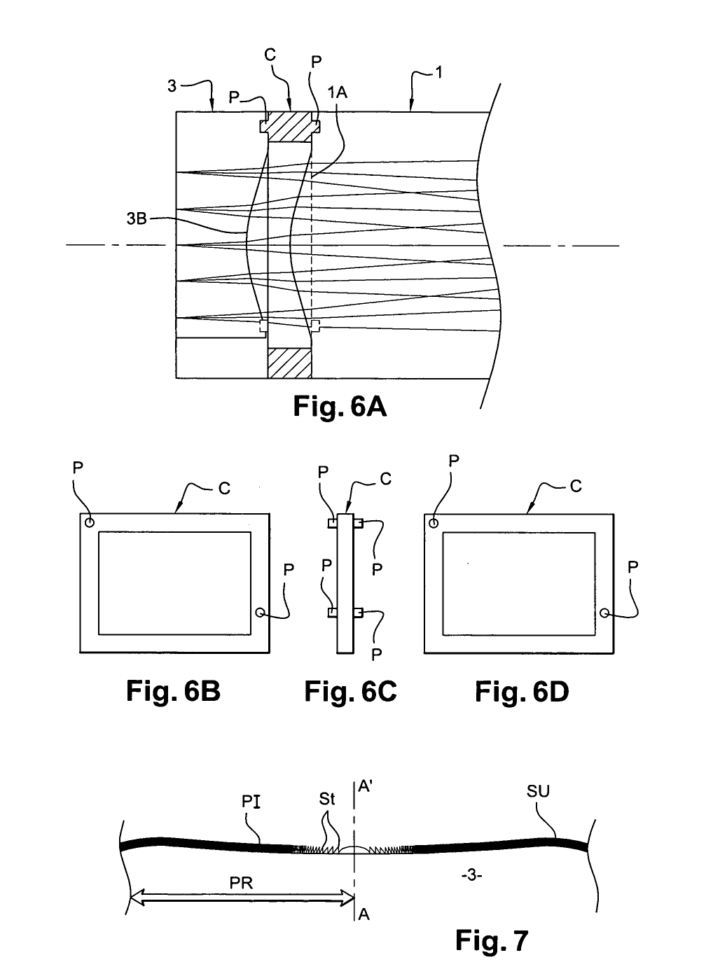

FIGS. 6A to 6D are longitudinal section and face views of a second variant embodiment of the interface between the field lens and the light pipe.

FIG. 7 is a detail view of a display in accordance with the invention.

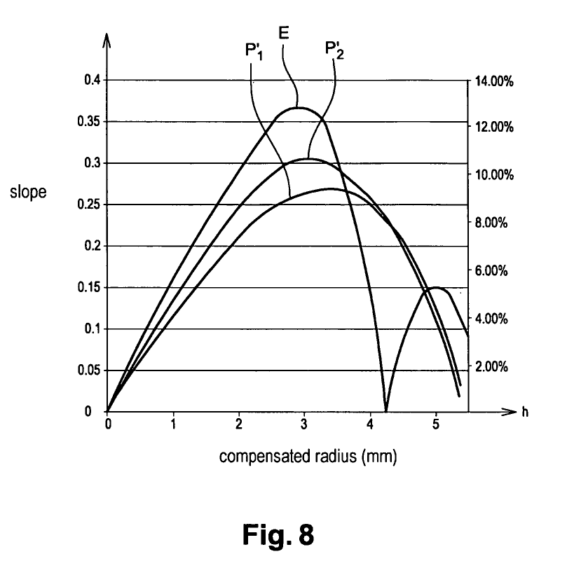

FIG. 8 is a graph comparing on a common radial abscissa the slope of the entry surface of the light pipe with the matching slope on the working surface of the aspherical surface of a field lens constituting the display in accordance with the invention.

As shown in FIG. 1, the invention relates to an electronic display arrangement comprising a light pipe 1 for conveying light signals emitted by a miniature screen 2 from one of its ends, referred to as an entry surface 1A, to its other end, referred to as its exit surface 1B, and thence towards the eye of a user to enable a virtual image to be viewed.

In the specific example shown, the light guide 1 comprises a light relay 1C in the form of a rectangular bar for conveying light along an optical axis that coincides with its longitudinal axis. At the end of this bar 1C remote from the entry surface 1A, there is placed a reflecting wall 1D that is inclined relative to said longitudinal axis. The exit surface 1B is in fact constituted by a lens having its axis of revolution contained in a longitudinal plane of symmetry.

By virtue of its length, the bar 1C enables the miniature screen 2 to be positioned far enough away from the temporal side of the wearer.

This arrangement also includes a field lens 3 interposed between the screen and the entry surface, having a plane working surface 3A facing the screen 2 centered on the optical axis of the field lens, and an aspherical working surface 3B that is disposed facing the entry surface 1A, the optical axis of the field lens and the optical axis of the light pipe coinciding.

A thin air gap is arranged between the entry surface 1A and the field lens 3. It is preferably less than 4 millimeters (mm) thick at the center.

As shown in the figures, the plane working surface 3A of the field lens is preferably adhesively bonded on the screen 2, and more precisely on the protective glass slide 2B that covers the active element 2A of the screen.

The invention proposes several variant embodiments for this interface between the screen and the field lens.

As shown in FIG. 2, the working surface 3A of the field lens is plane and is thus applied by adhesive against the protective glass slide 2B of the screen.

The fact of bearing against a plane face simplifies the design of the mechanical arrangement for moving the screen 2 in order to adjust left-right image alignment in a binocular configuration. Thereafter, once alignment has been obtained by means of an optical bench provided for this purpose, it is possible to set the adhesive by exposure to appropriate ultraviolet (UV) illumination.

It is necessary to control the emission spectrum from the screen quite precisely to ensure that it does not contain any UV that might cause the adhesive to set while adjustment is taking place, which imposes a constraint on the filters of the screen. One solution is to use the red or green portion of the light spectrum during the adjustment stages in order to minimize any risk of the adhesive setting.

In FIG. 2, the optimization zone where rays are traced is greater than the active surface area of the screen in order to accommodate the amplitude of alignment adjustment movements and to ensure a good quality image over the entire alignment adjustment range.

FIGS. 3 and 4 show other variant embodiments of the interface between the screen and the field lens.

Here alignment is adjusted not by moving the positioning of the screen 2, but by moving the image electronically.

More precisely, the screen 2 presents an active surface area that is greater than the area determined for the emitted image. The adjustment method then consists in moving the emitted image over the screen so as to obtain an adjusted position for the image relative to the screen that corresponds to superposing left and right virtual images in a binocular configuration.

The screen, and more precisely its protective slide 2B, can thus be engaged or embedded in an arrangement for determining their positioning relative to the field lens 3.

A housing or complementary shape is formed in the plane face of the field lens 3 in order to receive the protective slide 2B of the screen, which side is adhesively bonded thereto. This housing or complementary shape is such as to enable the active area of the screen 2 to be positioned so as to be centered on the optical axis of the field lens 3, this axis coinciding with the axis of the optical system.

In FIG. 3, the optimization zone where rays are traced is the same as the active surface area of the screen since in this variant the image is moved electronically.

This housing for the protective slide 2B of the screen may have four walls P1, P3 disposed all around the periphery of the plane surface 3A of the field lens, as shown for the second variant in FIG. 3, or merely two walls P′1, P′2 that are perpendicular and disposed on two adjacent sides of the plane surface 3A of the field lens, as illustrated by the third variant shown in FIGS. 4A and 4B.

This housing with its walls can easily be obtained during injection molding of the field lens 3.

The accuracy of alignment is ensured during development of the mold by acting directly on the shape thereof and thus on the shape of the molded field lens.

The screen 2 is assembled with the plane surface of the field lens 3 and more particularly with its working optical zone, by using an appropriate optical adhesive.

In these variants, there is no need to align the right and left virtual images at the time the miniature screen is stuck onto the field lens. As recommended above, during design of the system, it suffices merely to align the center of the active zone of the screen on the optical axis of the field lens 3 and thus on the optical axis of the system, while accurately controlling fabrication tolerances. This has the advantage of minimizing the excursion of the image display zone needed for aligning the right virtual image on the left virtual image, i.e. minimizing the size of the working zone of the miniature screen, and thus limiting the overall size of the binocular eyeglasses. Each field lens and each miniature screen can thus be bonded together individually independently and prior to aligning the right and left virtual images, thereby considerably simplifying the alignment operation and thus reducing the fabrication costs of the binocular eyeglasses and also the overall size thereof since the external mechanical adjustment devices used in the prior art are replaced merely by adhesive.

There follows a more detailed description of the structure of the interface between the field lens 3 and the light pipe 1, which interface includes an air gap between these two elements, as mentioned above.

In a first variant, as shown in FIGS. 5A to 5C, the field lens 3 and the light pipe 1 are shaped so as to have mechanical interface zones outside their working optical zones. These interface zones are disposed at the periphery of the aspherical working surface 3B and of the aspherical entry surface 1A of the light pipe. These mechanical interface zones serve to align the optical axis L3 of the interface 3 with the optical axis L1 of the light pipe 1. This is made possible by making these two elements by injection molding, thereby making it possible to adapt the shape of the mold of the part to enable it to perform these mechanical functions.

More precisely, around the respective working zones Z3 and Z1, and at the peripheries thereof, the exit surface 3B of the field lens and the entry surface 1A of the light pipe have respective flanges B3 and B1 including an arrangement of mutually-engageable pegs and holes. The field lens 3 has two pegs P3 and P3′, while the light pipe has two corresponding holes T1 and T1′ in which the pegs are engaged.

The assembly of the two parts is held in position by using an appropriate adhesive.

Because of the great accuracy acquired during development and because of the repeatability of the method, it is possible to align these two parts very accurately and thus ensure that the center of the active zone of the screen 2 lies on their common optical axis. The optical system is thus aligned by adjusting the mold during injection and while developing the method. Once the system is in production, assembly is simple and requires no external instrument.

Nevertheless, in order to avoid the need to make molds that are complex for these two optical parts, a second variant embodiment is shown in FIGS. 6A to 6D.

The junction between these parts may alternatively be made with the help of an intermediate spacer frame C that is made by injection molding. Advantageously, in order to avoid any parasitic reflection, it is made of black opaque material or its sides having a ground finish.

The frame C has plane bearing zones with positioning pegs P on each of its faces, preferably two pegs on each of its faces, so as to be positioned relative to the field lens 3 and to the light pipe 1, both of which have corresponding holes in their exit face 3B or entry face 1A, as appropriate. A keying system, e.g. resulting from the positioning of the pegs on either side, can serve to ensure that the frame C can only be mounted in the right configuration so as to avoid any off-centering or prismatic defects that might otherwise occur if the parts were assembled in the wrong configuration.

In order to minimize the value of transverse chromatic aberration, a diffractive surface is used on the aspherical exit face 3B of the field lens 3 and/or on the aspherical entry face 1A of the light pipe 1.

It is possible to use a single asphero-diffractive surface, positioned either on the exit face of the field lens 3 or on the entry face of the light pipe 1, or else to use two asphero-diffractive surfaces, one on each of those two elements.

The advantage of positioning the asphero-diffractive faces at this location, is that there they are protected from any environmental attack.

The thickness of the field lens 3 is defined in such a manner that the vergence of the image of the diffractive surface of the field lens is situated outside the standard accommodation ranges of ametropic user. In order to avoid the observer of the virtual image of the miniature screen 2 focusing the “kinoform” that might be present on the field lens 3, the field lens is relatively thick. Its thickness is calculated so that the vergence of the diffractive image on the face of the field lens is either greater than 0 diopters, preferably +2 diopters, or else less than −4 diopters, preferably −6 diopters; alternatively, it may be spaced apart from the vergence of the image of the screen 2 by at least 4 diopters in absolute value.

By way of example, the thickness of the field lens 3 is at least 3 mm, and preferably 3.5 mm.

FIG. 7 is a cross-section through a asphero-diffractive surface constituting the exit surface of the field lens and/or the entry surface of the light pipe.

The working surfaces SU of the aspherical surfaces 3B or 1A are defined as being the smallest disk of diameter D that includes all of the impact points of light rays in the ray trace for an eye having a pupil of 8 mm or less. The area of the working surface SC of the exit surface 3B of the field lens is different from the area of the working surface SE of the entry surface 1A of the light pipe. The surfaces SC and SE include an aspherical carrier and possibly also a kinoform, and they may be referred to as “improved”.

One of the fundamental characteristics for controlling astigmatism and field curvature is that on the working surfaces SC or SE of the aspherical surfaces, the radial profile of the aspherical surfaces or of the aspherical carriers presents at least one local inversion of the sign of its curvature.

More precisely, and advantageously, these aspherical surfaces include in each of their working surfaces SU at least one point of inflection PI in its radial profile at which the second derivative relative to radial distance from the center of the working surface becomes zero and changes sign on passing through zero.

This aspherical surface is also a surface of revolution. Over the working surface SU, the sign of the second derivative of the radial profile of this carrier surface of the diffractive surface changes at least once. In the example shown, this surface presents a point of inflection PI along its radial profile PR at which the change-of-sign condition for the second derivative is satisfied.

If the equation of the radial profile is written Z(h), that means that over the definition domain or working domain corresponding to the portion of space over which the working surface is defined, there exists at least one value h0 such that:

(d²Z/dh²)(h0)=0

and changes sign on passing through h0.

More generally, the improved surface SE or SC comprises a working surface through which light coming from the miniature screen passes on its way to the wearer's eye for which there exists an inversion of the sign of its local curvature.

With the impact radius on this working surface SU being written h, the carrier aspherical surface of the diffractive component satisfies the following equation:

Zsupport(h)=c₁·h²/(1+SQRT(1−(1+k₁)·c₁²·h²)+A₁·h⁴+B₁·h⁶+C₁·h⁸+D₁·h¹⁰+E₁·h¹²+F₁·h¹⁴+G₁·h¹⁶+H₁·h¹⁸+J₁·h²⁰

where:

Zsupport(h) is the coordinate of the surface parallel to the axis z;

c₁ is the curvature at the pole of the surface;

k₁ is the conic coefficient; and

A₁, B₁, C₁, . . . are the polynomial coefficients of the asphericity of the surface.

Zsupport(h) is the general equation of an aspherical surface of revolution.

The diffractive surface is made up of concentric stripes or furrows St relative to said working surface SU: this produces a profile known as a “kinoform”.

The equation of the diffractive surface is written like that of an aspherical surface of revolution modulo a step size s:

D(h)=mod [Zdiffract(h),s]

with:

Zsupport(h)=c₂·h²/(1+SQRT(1−(1+k₂)·c₂²·h²)+A₂·h⁴+B₂·h⁶+C₂·h⁸+D₂·h¹⁰+E₂·h¹²+F₂·h¹⁴+G₂·h¹⁶+H₂·h¹⁸+J₂·h²⁰

where:

Zdiffract(h) is the coordinate of the surface parallel to the axis z;

c₂ is the curvature at the pole of the surface;

k₂ is the conic coefficient; and

A₂, B₂, C₂, . . . represents the polynomial coefficients of the asphericity of the surface; and

s=λ/[n(λ)−1]

where:

λ is the design wavelength of the diffractive component, generally selected to lie in the middle of the visible band of the light spectrum, i.e. in this example 550 nanometers (nm); and

n(λ) is the refractive index of the material constituting the light pipe at the design wavelength λ under consideration.

The equation for the surface shown in FIG. 7 can thus be written in the form:

Z(h)=Zsupport(h)+Zdiffract(h)

Preferably, the aspherical carriers of the working surfaces SC and SE are of opposite concavities. Furthermore, the entry surface 1A of the light pipe and the aspherical working surface 3B of the lens are substantially parallel.

For a given radial abscissa, the absolute value of the difference between the slope of said entry surface of the light pipe and the slope of said aspherical working surface of the lens is preferably less than 20% of the maximum value of the slope of one or the other of these surfaces at that abscissa value.

This condition of the aspherical carriers of the working surfaces SC and SE being almost parallel is very important for obtaining a good design in the configuration used.

This condition naturally relates to the working surfaces SC and SE where the light beams pass through them. As a general rule, the areas of the working surfaces of SC and SE are slightly different because of the divergence of the light beams.

A ratio Ru(p) referred to as the “harmonization coefficient” of the working surfaces of SC and SE is defined as follows:

$$Ru ( p ) = \frac{area of the working surface ( SE )}{area of the working surface ( SC )}$$

for a given value of pupil diameter p. Ru is preferably calculated for a pupil diameter equal to 8 mm.

Below, Ru applies for a pupil diameter of at least 8 mm.

The area of the working surface of SC over the area of the working surface of SE is adjusted by an affinity of coefficient Ru.

The function of the slopes of SC over the new working surface is then extended by an affinity of coefficient Ru along the ordinate axis Z.

The equation for the slopes of SC harmonized on the working surface of SE is then written:

Z_{—}SC−harmon(h)=Z_{—}SC(h/Ru)

where:

Z_{—}SC(h)=d/dh[c₁·h²/(1+SQRT(1−(1+k₁)·c₁²·h²)+A₁·h⁴+B₁·h⁶+C₁·h⁸+D₁·h¹⁰+E₁·h¹²+F₁·h¹⁴+G₁·H¹⁶H₁·h¹⁸+J₁h²⁰]

where:

Z_SC(h) is the first derivative in h of the surface SC;

c₁ is the curvature of the pole of the surface;

k₁ is the conic coefficient; and

A₁, B₁, C₁, . . . are the polynomial coefficients of the asphericity of the carrier of the surface SC. Z_SC(h) is the first derivative of an aspherical surface of revolution.

FIG. 8 is a graph plotting, as a function of radial abscissa h, firstly the value of the slope P′₁ of the carrier of the entry surface 1A of the light pipe over its working surface SE, and secondly the value of the slope P′₂ of the carrier of the aspherical exit surface 3B of the field lens harmonized to match the aspherical working surface SE of the light pipe, where this is plotted relative to the left ordinate axis and in arbitrary units, and secondly the relative difference E between these two values relative to the maximum of the two slopes, where this is plotted relative to the right-hand ordinate axis in %.

In order to optimize correction of chromatic aberration of the proposed optical combination, the entry surface 1A of the light pipe and the aspherical working surface 3B of the field lens are of the “kinoform” type.

This makes it possible:
to fold the transverse chromatic aberration spot twice, thereby improving correction; and
to share the diffractive power over both surfaces, thus making it possible to use fewer rings and to be less subject to higher-order parasitic defects.

A preferred combination consists in balancing power between the two diffractive surfaces over the faces SE and SC so as to make them as equal as possible.

These values are preferably selected so that:

$$ABS \frac{Pdiffract ( SC ) - Pdiffract ( SE )}{max [ Pdiffract ( SC ) , Pdiffract ( SE ) ]}$$

is less than or equal to 25%.

Alternatively, another favorable arrangement consists in balancing the number of rings on the working surfaces of SC and SE. If these numbers of rings on the working surfaces of SC and SE are written N_SE and N_SC respectively, then it should be ensured that:

ABS[(Ru·N_SC)−N_SE]/max[(Ru·N_SC),N_SE]

is less than or equal to 25%, Ru being the harmonization coefficient of the working surfaces SC and SE of the entry face 1A of the light pipe and the aspherical surface 3B of the field lens.

Preferably, in the invention, the screen has color pixels of a size of less than 11 μm.

The advantage of this is to avoid increasing the size of the screen directly in proportion to its resolution, thereby minimizing the final overall size of the binocular eyeglasses.

By means of the invention, it is possible to obtain virtual image sizes that are greater than 21°, with an effective focal range of the system being less than 22 mm, and while using VGA or better screen resolution.

The component parts are preferably made by thermoplastic injection molding techniques using Zeonex, e.g. of grade 330R, selected for its very good optical properties, its low birefringence, and its low water absorption.

1. An electronic display arrangement having a light pipe for transmitting light signals emitted by a miniature screen from one of its ends, referred to as its entry surface, to its other end, referred to as its exit surface, and thence towards the eye of a user for viewing a virtual image, the arrangement comprising:
a field lens interposed between said screen and said entry surface, the field lens having both a plane working surface of rectilinear section that is placed facing the screen centered on the optical axis of said field lens, and an aspherical working surface, wherein said aspherical surface is placed facing said entry surface, with the optical axis of the field lens and the optical axis of the light pipe coinciding, and in that said plane working surface is adhesively bonded to the screen.

2. An arrangement according to claim 1, wherein the screen is engaged in at least in part in said plane working surface.

3. An arrangement according to claim 1, wherein said entry surface and said aspherical working surface are separated by an air gap.

4. An arrangement according to claim 3, wherein said field lens is positioned relative to the light pipe by means of an arrangement of at least two pegs co-operating with at least two corresponding holes.

5. An arrangement according to claim 4, wherein the two pegs are carried by said field lens and the two holes by the entry surface of the light pipe.

6. An arrangement according to claim 4, wherein said pegs are carried by a spacer frame and said holes by the entry surface of the light pipe and by the exit surface of the field lens.

7. An arrangement according to claim 1, wherein said aspherical working surface is diffractive.

8. An arrangement according to claim 7, wherein the thickness of said field lens is defined so that the vergence of the image of the diffractive surface of the field lens lies beyond the standard accommodation ranges of an ametropic user.

9. An arrangement according to claim 8, wherein the vergence of the image of the diffractive surface of the field lens is either greater than 0 diopters or less than −4 diopters.

10. An arrangement according to claim 8, wherein the vergence of the image of the diffractive surface of the field lens is spaced apart from the vergence of the image of the screen by at least 4 diopters in absolute value.

11. An arrangement according to claim 1, wherein said diffractive aspherical working surface is of the “kinoform” type, satisfying the equation for an aspherical carrier surface of revolution summed with the equation for a second aspherical component of revolution modulo a step size.

12. An arrangement according to claim 1, wherein said aspherical working surface has a light-passing surface that presents local curvature that changes sign at least once.

13. An arrangement according to claim 1, wherein said aspherical working surface includes at least one point of inflection in its radial profile at which the second derivative relative to radial distance from the center of the working surface becomes zero and changes sign on passing through zero.

14. An arrangement according to claim 1, wherein said light pipe also includes an aspherical diffractive surface on its entry surface.

15. An arrangement according to claim 14, wherein the diffractive aspherical working surface of the entry surface of said light pipe is of the “kinoform” type, satisfying the equation for an aspherical carrier surface of revolution summed with the equation for a second aspherical component of revolution modulo a step size.

16. An arrangement according to claim 14, wherein the aspherical carrier of said aspherical working surface of the entry surface of said light pipe has a light-passing surface that presents local curvature that changes sign at least once.

17. An arrangement according to claim 14, wherein said aspherical working surface of the entry surface of said light pipe includes at least one point of inflection in its radial profile at which the second derivative relative to radial distance from the center of the working surface becomes zero and changes sign on passing through zero.

18. An arrangement according to claim 14, wherein said entry surface of the light pipe and said aspherical working surface of the field lens are substantially parallel.

19. An arrangement according to claim, the absolute value of the difference at a given radial abscissa between the slopes of said inlet working surface (1A) of the light pipe and the harmonized slopes on the working surface of said aspherical working surface (3B) of the field lens is less than 20% of the maximum value of one or other of said values at said abscissa.

20. An arrangement according to claim 15, wherein the absolute value of the difference between the diffractive powers of the entry faces of the light pipe and of the aspherical surface of said field lens, divided by the maximum of said diffractive powers, is less than or equal to 0.25.

21. An arrangement according to claim 15, wherein it is ensured that:
ABS[(Ru·N_SC)−N_SE]/max[(Ru·N_SC),N_SE]
is less than or equal to 25, where:
N_SE is the number of rings on the working surface (SC) of the entry face (1A) of the light pipe;
N_SC is the number of rings on the working surface (SE) of the aspherical surface (3B) of said field lens; and
Ru is the harmonization coefficient of the working surfaces of the entry faces (1A) of the light pipe and the aspherical surface (3B) of said field lens, defined by the area of the working surface (SE) of the entry face (1A) of the light pipe divided by the area of the working surface (SC) of the aspherical surface (3B) of said field lens, for a given value of pupil diameter.

22. An arrangement according to claim 21, wherein Ru is calculated for a pupil diameter equal to 8 mm.

23. An arrangement according to claim 1, wherein said screen has color pixels of size less than 11 μm.
